(19) United States
(12) Patent Application Publication
(10) Pub. No.: US 2020/0160854 A1
(43) Pub. Date: May 21, 2020

(54) VOICE RECOGNITION SUPPORTING DEVICE AND VOICE RECOGNITION SUPPORTING PROGRAM

(71) Applicant: TOYOTA JIDOSHA KABUSHIKI KAISHA, Toyota-shi (JP)

(72) Inventors: Keiko Suzuki, Suginami-ku (JP); Satoshi Aihara, Shinjuku-ku (JP)

(73) Assignee: TOYOTA JIDOSHA KABUSHIKI KAISHA, Toyota-shi (JP)

(21) Appl. No.: 16/656,659

(22) Filed: Oct. 18, 2019

(30) Foreign Application Priority Data
Nov. 16, 2018 (JP) 2018-215240

(51) Int. Cl. G10L 15/20; G10L 15/22; G10L 25/84; H05B 37/02; H05B 33/08

(52) U.S. Cl. CPC G10L 15/20; G10L 15/22; B60R 16/0373; H05B 37/0236; H05B 33/0872; G10L 25/84

(57) ABSTRACT

A voice recognition supporting device includes a light emitting unit, a sound detecting unit, and an emission control unit configured to determine whether an environment around the sound detecting unit is suitable for recognition of a voice based on a voice level, a noise level, and a threshold value, to change an emission state of the light emitting unit to a first state when it is determined that the environment around the sound detecting unit is suitable for recognition of a voice, and to change the emission state of the light emitting unit to a second state which is different from the first state when it is determined that the environment around the sound detecting unit is not suitable for recognition of a voice.

### INCORPORATION BY REFERENCE

The disclosure of Japanese Patent Application No. 2018-215240 filed on Nov. 16, 2018 including the specification, drawings and abstract is incorporated herein by reference in its entirety.

### BACKGROUND

### 1. Technical Field

The disclosure relates to a voice recognition supporting device and a voice recognition supporting program that support a voice recognition function using a voice recognition device.

### 2. Description of Related Art

Japanese Unexamined Patent Application Publication No. 2014-178339 (JP 2014-178339 A) discloses a technique of performing a process of noise reduction in conjunction with an operation of a switch and turning on a lamp for notifying that utterance is possible when the switch is pushed at a time at which a speaker wants to converse with the outside. The switch is a starting means for starting a noise reduction circuit.

### SUMMARY

However, in the technique disclosed in JP 2014-178339 A, since a speaker cannot be notified that a current environment is not suitable for voice recognition because a noise level is higher than a voice level, a speaker is notified that utterance is possible even when the switch is pushed in an environment which is not suitable for voice recognition. When a voice is uttered in such an environment, there is a high likelihood that a voice will not be accurately recognized and thus a voice needs to be repeatedly uttered.

The disclosure is for enabling a speaker to understand whether a current environment is suitable for voice recognition.

According to an aspect of the disclosure, there is provided a voice recognition supporting device including: a light emitting unit; a sound detecting unit; and an emission control unit configured to determine whether an environment around the sound detecting unit is suitable for recognition of a voice based on a voice level indicating a level of a person's voice which is detected by the sound detecting unit, a noise level indicating a level of noise which is detected by the sound detecting unit, and a threshold value for determining whether an environment around the sound detecting unit is suitable for recognition of a voice, to change an emission state of the light emitting unit to a first state when it is determined that the environment around the sound detecting unit is suitable for recognition of a voice, and to change the emission state of the light emitting unit to a second state which is different from the first state when it is determined that the environment around the sound detecting unit is not suitable for recognition of a voice.

According to this configuration, it is possible to enable a speaker to understand whether a current environment is suitable for voice recognition using an emission state of the light emitting unit. Since a speaker can understand whether the current environment is suitable for voice recognition, it is possible to prevent an increase in a person's cognitive load.

In the aspect of the disclosure, the emission control unit may be configured to determine whether an environment in a vehicle is suitable for recognition of a voice based on vehicle information which is acquired from the vehicle in addition to the voice level and the noise level.

According to this configuration, even when a noise level is high, it is possible to provide a comfortable driving environment effectively using a voice recognition device by increasing accuracy of voice recognition.

In the aspect of the disclosure, the emission control unit may be configured to determine that the environment in the vehicle is suitable for recognition of a voice when it is determined that the vehicle is not running based on the vehicle information.

According to this configuration, an occupant can use a voice recognition device without being aware of the emission state of the light emitting unit.

In the aspect of the disclosure, the emission control unit may be configured to turn off the light emitting unit when it is determined that the vehicle is not running.

According to this configuration, it is possible to curb consumption of power which is required for emission of light from the light emitting unit.

Another embodiment of the disclosure can be realized as a voice recognition supporting program.

According to the disclosure, it is possible to enable a speaker to understand whether a current environment is suitable for voice recognition.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an example of a configuration of a voice recognition supporting device according to a first embodiment of the disclosure;

FIG. 2 is a sequence chart illustrating an operation of the voice recognition supporting device according to the first embodiment of the disclosure;

FIG. 3 is a flowchart illustrating an operation of the voice recognition supporting device according to the first embodiment of the disclosure;

FIG. 4 is a diagram illustrating a first example of an emission state correspondence table;

FIG. 5 is a diagram illustrating a second example of the emission state correspondence table;

FIG. 6 is a diagram illustrating an example of a hardware configuration for embodying the voice recognition supporting device according to the first embodiment of the disclosure;

FIG. 7 is a diagram illustrating an example of a configuration of a voice recognition supporting device according to a second embodiment of the disclosure;

FIG. 8 is a sequence chart illustrating an operation of the voice recognition supporting device according to the second embodiment of the disclosure;

FIG. 9 is a flowchart illustrating an operation of the voice recognition supporting device according to the second embodiment of the disclosure; and

FIG. 10 is a diagram illustrating an example of a hardware configuration for embodying the voice recognition supporting device according to the second embodiment of the disclosure.

### DETAILED DESCRIPTION OF EMBODIMENTS

Hereinafter, embodiments of the disclosure will be described with reference to the accompanying drawings.

### First Embodiment

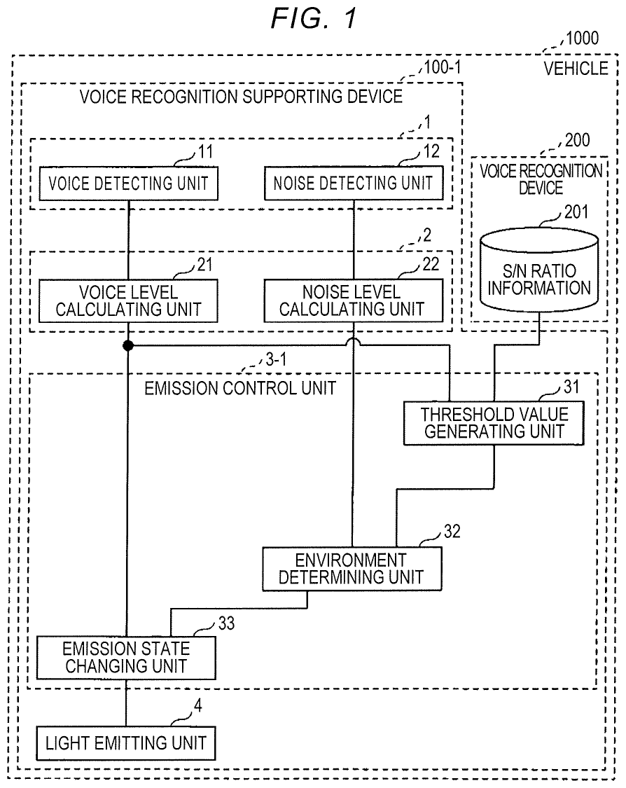

FIG. 1 is a diagram illustrating an example of a configuration of a voice recognition supporting device according to a first embodiment of the disclosure. A “voice” is “sound which is uttered by a person” (Kojien, the sixth edition). A voice recognition supporting device 100-1 is a device that supports a voice recognition function of a voice recognition device 200. The voice recognition device 200 is a device that recognizes a voice which is uttered by a person in a vehicle 1000 and performs a specific operation. Examples of the specific operation include voice manipulation of a navigation device and automatic calling to a phone. In order to enable the voice recognition device 200 to accurately recognize a voice, a current environment has to be an environment in which a voice level is higher than a noise level. “Noise” is sound other than a voice and examples thereof include road noise which is generated due to friction between a tire of the vehicle 1000 and a road surface during running, wind sound which is generated in the vehicle 1000 during running, sound which is generated when rainfall comes into contact with a front windshield or the like of the vehicle 1000, and music which is emitted from an acoustic device in the vehicle 1000. A noise level is an index indicating a magnitude of noise and is a sound pressure level of noise which is expressed in [dB] (decibel). A voice level is an index indicating a magnitude of a voice and is a sound pressure level of a voice which is expressed in [dB]. In the following description, the “vehicle 1000” may be abbreviated to a “vehicle” for the purpose of simplification of explanation.

When a noise level is higher than a voice level, the voice recognition device 200 has difficulty in recognizing speech and is likely to erroneously recognize contents of speech. Recognition of a voice by the voice recognition device 200 varies depending on a ratio of a voice level to a noise level (an S/N ratio). For example, when a speed of a vehicle is in a low-speed area (for example, equal to or lower than 30 km/h), the noise level is lowered to a level at which an occupant of the vehicle, that is, a driver or a passenger does not feel harsh. Accordingly, in this environment, the likelihood that the voice recognition device 200 will recognize a voice is increased even when a voice is uttered with a relatively small sound volume. On the other hand, when a speed of a vehicle is in a high-speed area (for example, equal to or higher than 80 km/h), the noise level reaches a level at which an occupant feels it is harsh. Accordingly, in this environment, the likelihood that the voice recognition device 200 will recognize a voice is decreased even when a voice is uttered with a relatively large sound volume. In this way, a voice recognition rate varies depending on the S/N ratio in the vehicle. Accordingly, in order to enable the voice recognition function of the voice recognition device 200 to work normally, it is effective to notify an occupant whether a current environment is voice-recognizable without being affected by noise.

In the technique disclosed in JP 2014-178339 A, a noise reducing process is performed in conjunction with an operation of a switch and a lamp for notifying that utterance is possible is turned on. However, in the technique disclosed in JP 2014-178339 A, a speaker cannot be notified whether a current environment is not suitable for voice recognition. Japanese Unexamined Patent Application Publication No. 11-316598 (JP 11-316598 A) discloses a technique of displaying a noise value, a signal-to-noise (S/N) ratio, or the like on a display unit in order to determine whether a current environment is voice-recognizable without being affected by noise. In this technique, numerical values such as a noise level and an S/N ratio can be visually provided to a person who utters a voice. However, it is difficult to enable a person to intuitively understand whether a displayed numerical value is suitable for voice recognition. Japanese Unexamined Patent Application Publication No. 2006-227499 (JP 2006-227499 A) discloses a technique of displaying a voice volume and a noise volume in a graph for comparison. In this technique, it is possible to enable a person who utters a voice to understand with what sound volume the person has to utter a voice. However, when a voice volume is less than a noise volume which is displayed, a person has to adjust a voice volume such that the voice volume is greater than the noise volume. Accordingly, a person's cognitive load in understanding a voice volume which is displayed or the like is likely to increase. Here, a cognitive load is a burden on a person in understanding a voice volume and a noise volume which are displayed. Japanese Patent No. 5075664 discloses a technique of estimating a distance between a microphone and a user based on a voice intensity level of the user and presenting an estimated distance to the user. In this technique, a user can be notified whether the distance between the microphone and the user is a voice-recognizable distance. However, in this technique, since a difference between an actual distance and an estimated distance from a person to a microphone cannot be understood, it is necessary to adjust a distance to the microphone while checking an estimated distance normally. Accordingly, a person's cognitive load in understanding an estimated distance is likely to increase.

In consideration of the above-mentioned problems, the voice recognition supporting device 100-1 is configured to ascertain whether a current environment is suitable for voice recognition while curbing an increase in a person's cognitive load. An example of a configuration of the voice recognition supporting device 100-1 will be first described below and then an operation of the voice recognition supporting device 100-1 will be described then.

Referring back to FIG. 1, the voice recognition supporting device 100-1 includes a sound detecting unit 1, a sound level calculating unit 2, and an emission control unit 3-1. The sound detecting unit 1 includes a voice detecting unit 11 and a noise detecting unit 12. The voice detecting unit 11 is a voice detecting microphone that detects a voice which is uttered by an occupant in the vehicle as a vibration waveform and outputs a single indicating the detected vibration waveform as voice information. The noise detecting unit 12 is a noise detecting microphone that detects noise in the vehicle as a vibration waveform and outputs a signal indicating the detected vibration waveform as noise information. The voice detecting unit 11 and the noise detecting unit 12 are employed in the voice recognition supporting device 100-1, but the sound detecting unit 1 may be constituted by a single microphone. In this case, the sound detecting unit 1 divides a frequency component of a vibration waveform of sound detected by a single microphone into bands, for example, using fast Fourier transform or a band-pass filter and outputs information of a voice signal and a noise signal. A technique of analyzing sound detected by a single microphone is known, for example, as disclosed in Japanese Unexamined Patent Application Publication No. 2016-174376 (JP 2016-174376 A), Japanese Unexamined Patent Application Publication No. 2013-169221 (JP 2013-169221 A), and the like and thus detailed description thereof will be omitted.

The sound level calculating unit 2 includes a voice level calculating unit 21 and a noise level calculating unit 22. The voice level calculating unit 21 calculates a vibration waveform level of a voice based on voice information which is output from the voice detecting unit 11 and outputs the calculated vibration waveform level as voice level information. The unit of a vibration waveform level is [dB]. The noise level calculating unit 22 calculates a vibration waveform level of noise based on noise information which is output from the noise detecting unit 12 and outputs the calculated vibration waveform level as noise level information. A technique of calculating a noise level is known, for example, as disclosed in Japanese Unexamined Patent Application Publication No. 2015-114270 (JP 2015-114270 A), Japanese Unexamined Patent Application Publication No. 2010-103853 (JP 2010-103853 A), and the like and thus detailed description thereof will be omitted.

The emission control unit 3-1 includes a threshold value generating unit 31, an environment determining unit 32, and an emission state changing unit 33. The threshold value generating unit 31 generates a threshold value for determining whether an environment in the vehicle is suitable for recognition of a voice based on S/N ratio information 201 which is output from the voice recognition device 200. An S/N ratio indicates a ratio of a voice level to a noise level. The S/N ratio information 201 is information for determining whether a voice level acquired by the voice recognition device 200 is a voice-recognizable level.

The environment determining unit 32 determines whether the environment in the vehicle is suitable for recognition of a voice based on the threshold value generated by the threshold value generating unit 31 and the noise level information calculated by the noise level calculating unit 22 and outputs determination result information indicating the result of determination. Determination result information is information indicating that the environment in the vehicle is suitable for recognition of a voice or information indicating that the environment in the vehicle is not suitable for recognition of a voice.

The emission state changing unit 33 outputs, for example, dimming information for changing an emission state of a light emitting unit 4 based on the voice level information output from the voice level calculating unit 21 and the determination result information output from the environment determining unit 32. Dimming information is, for example, information for designating a light intensity level of the light emitting unit 4, information for designating a color temperature of the light emitting unit 4, or command information for setting the light emitting unit 4 to a turned-on state, a flickering state, or a turned-off state.

The light emitting unit 4 is a light emitting diode of which at least one of a color temperature and illuminance can be adjusted based on the dimming information output from the emission state changing unit 33. The light emitting unit 4 is not limited to a light emitting diode and examples thereof include an organic electroluminescence element, a laser diode element, and a small incandescent lamp. The light emitting unit 4 is provided, for example, at a position which can be seen from an occupant in the vehicle. Examples of the position which can be seen from an occupant in the vehicle include an instrument panel in front of a driver's seat, a dash board, a door, a steering wheel, and a seat. The light emitting unit 4 is not limited to a light emitting means that is dedicatedly provided to notify whether the environment in the vehicle is suitable for recognition of a voice, and an existing lighting means in the vehicle may be utilized as the light emitting unit 4. Examples of the existing lighting means include an illumination lamp, a room lamp, a foot lamp, a door lamp, and a ceiling lamp. By utilizing an existing lighting means, design of a vehicle is facilitated and drawing-out of a wire connected to the light emitting means is not necessary in comparison with a case in which a dedicated lighting means is provided. Accordingly, it is possible to decrease costs for manufacturing a vehicle.

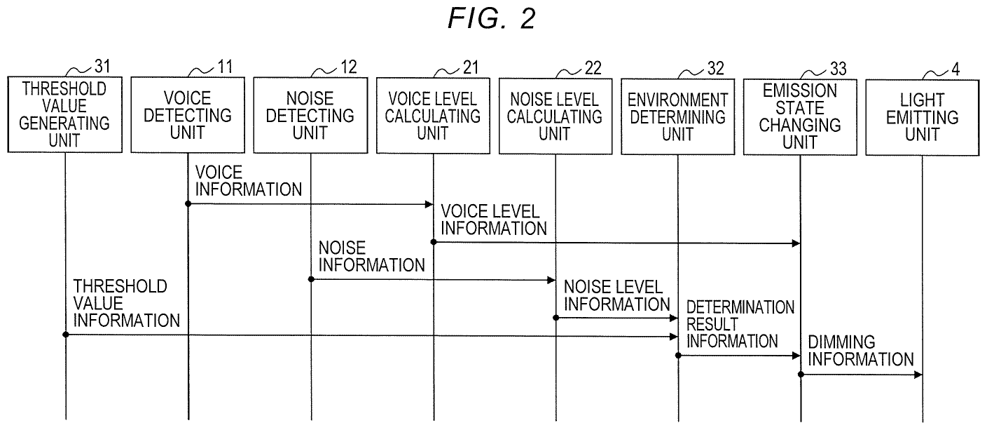

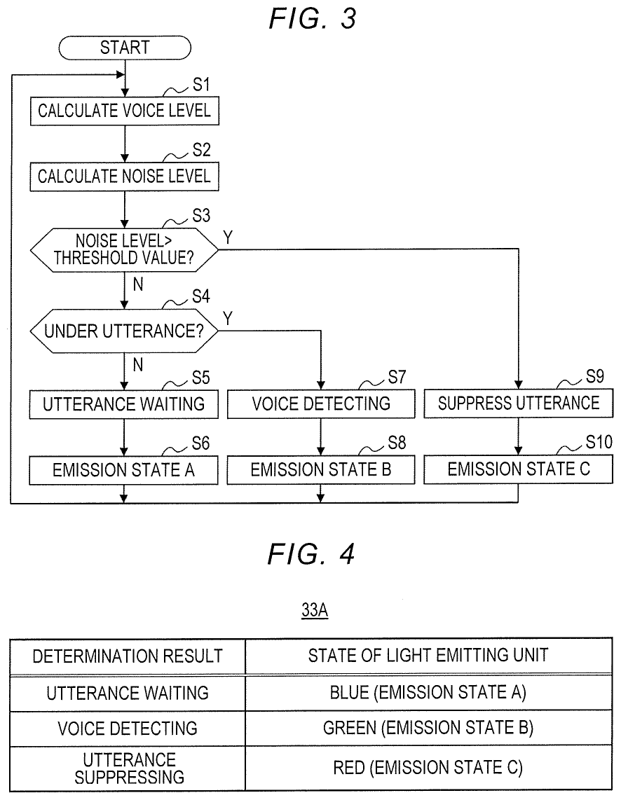

An operation of the voice recognition supporting device 100-1 will be described below with reference to FIGS. 2 to 5. FIG. 2 is a sequence chart illustrating the operation of the voice recognition supporting device according to the first embodiment of the disclosure. FIG. 3 is a flowchart illustrating the operation of the voice recognition supporting device according to the first embodiment of the disclosure. The voice level calculating unit 21 calculates voice level information based on voice information (Step S1) and the noise level calculating unit 22 calculates noise level information based on noise information (Step S2). The voice level information is input to the emission state changing unit 33 and the noise level information is input to the environment determining unit 32.

The environment determining unit 32 determines whether a noise level is greater than a threshold value based on the noise level information and the threshold value information (Step S3). When it is determined that the noise level is not greater than the threshold value (NO in Step S3), the environment determining unit 32 outputs determination result information indicating that the environment in the vehicle is suitable for recognition of a voice to the emission state changing unit 33. The emission state changing unit 33 having received the determination result information determines whether an occupant in the vehicle is uttering a voice based on the determination result information and the voice level information (Step S4). For example, when the voice level is less than a specific level similarly to a state in which no voice is detected, the emission state changing unit 33 determines that an occupant in the vehicle is not uttering a voice (NO in Step S4).

In this case, the emission state changing unit 33 determines that the environment in the vehicle is suitable for recognition of a voice and an occupant in the vehicle is waiting for uttering a voice (Step S5). Then, in order to notify an occupant that recognition of a voice is possible and utterance is being waited for, the emission state changing unit 33 outputs dimming information, for example, using an emission state correspondence table. The dimming information is information for controlling the emission state of the light emitting unit 4 such that the state of the light emitting unit 4 is set to “emission state A” (Step S6). Details of the emission state correspondence table will be described later.

Referring back to Step S4, for example, when the voice level is equal to or higher than the specific level and thus a voice is detected, the emission state changing unit 33 determines that an occupant in the vehicle is uttering a voice (YES in Step S4).

In this case, the emission state changing unit 33 determines that the voice recognition device 200 is recognizing a voice in an environment in the vehicle which is suitable for recognition of a voice (Step S7). Then, the emission state changing unit 33 outputs dimming information using the emission state correspondence table in order to notify an occupant that the voice recognition device 200 is recognizing a voice. The dimming information is information for controlling the mission state of the light emitting unit 4 such that the state of the light emitting unit 4 is set to “emission state B” (Step S8).

Referring back to Step S3, when the noise level is greater than the threshold value (YES in Step S3), the environment determining unit 32 outputs determination result information indicating that the environment in the vehicle is not suitable for recognition of a voice to the emission state changing unit 33. Then, since the environment in the vehicle is not suitable for recognition of a voice, the emission state changing unit 33 determines that it is necessary to prompt an occupant to suppress utterance of a voice (Step S9). Then, the emission state changing unit 33 outputs dimming information using the emission state correspondence table in order to prompt an occupant to suppress utterance of a voice. The dimming information is information for controlling the emission state of the light emitting unit 4 such that the state of the light emitting unit 4 is set to “emission state C” (Step S10).

FIG. 4 is a diagram illustrating a first example of the emission state correspondence table. In the emission state correspondence table 33A illustrated in FIG. 4, determination results of the emission state changing unit 33 are correlated with emission states of the light emitting unit 4. When the determination result is “utterance waiting,” the emission state corresponding thereto is “blue” (emission state A). Emission state A in the emission state correspondence table 33A is defined as a first state. When the determination result is “voice detecting,” the emission state corresponding thereto is “green” (emission state B). When the determination result is “utterance suppressing,” the emission state corresponding thereto is “red” (emission state C). Emission state C in the emission state correspondence table 33A is defined as a second state. The colors corresponding to the emission states are only an example, and the disclosure is not limited to the colors as long as they can notify an occupant whether the environment in the vehicle is suitable for recognition of a voice.

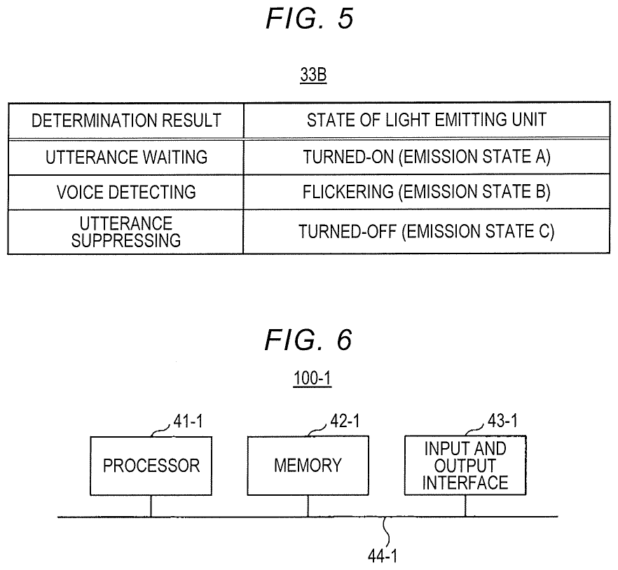

An example in which an emission color is changed is described herein, but a lighting state of the light emitting unit 4 may be changed as illustrated in FIG. 5 as long as it can indicate emission states such that an occupant can distinguish “utterance waiting,” “voice detecting,” and “utterance suppressing” from each other. FIG. 5 is a diagram illustrating a second example of the emission state correspondence table. The emission state correspondence table 33B illustrated in FIG. 5 is different from the emission state correspondence table 33A illustrated in FIG. 4, in that the emission state corresponding to “utterance waiting” is “turned-on” (emission state A), the emission state corresponding to “voice detecting” is “flickering” (emission state B), and the emission state corresponding to “utterance suppressing” is “turned-off” (emission state C). Emission state A in the emission state correspondence table 33B is defined as the first state. Emission state C in the emission state correspondence table 33B is defined as the second state.

Instead of the emission state correspondence table 33A and the emission state correspondence table 33B, for example, the emission state changing unit 33 may store a conversion expression for converting the determination result of whether the environment in the vehicle is suitable for recognition of a voice into correspondence such as an emission color, an emission intensity, and the like for each emission state and change the emission state using the conversion expression corresponding to the determination result.

FIG. 6 is a diagram illustrating an example of a hardware configuration for embodying the voice recognition supporting device according to the first embodiment of the disclosure. The voice recognition supporting device 100-1 can be embodied by a processor 41-1 such as a central processing unit (CPU) or a system large scale integration (LSI) circuit, a memory 42-1 including a random access memory (RAM) and a read only memory (ROM), and an input and output interface 43-1. The processor 41-1 may be a computing means such as a microcomputer or a digital signal processor (DSP). The processor 41-1, the memory 42-1, and the input and output interface 43-1 are connected to the bus 44-1 and can transmit and receive information to and from each other via the bus 44-1. The input and output interface 43-1 enables the voice recognition supporting device 100-1 to transmit and receive information to and from the voice recognition device 200 and the light emitting unit 4. When the voice recognition supporting device 100-1 is embodied, the sound level calculating unit 2 and the emission control unit 3-1 are embodied by storing a program for the voice recognition supporting device 100-1 in the memory 42-1 and causing the processor 41-1 to execute the program. The program for the voice recognition supporting device 100-1 is a voice recognition supporting program causing a computer to perform a determination step and an emission control step. The determination step is a process of determining whether an environment in the vehicle is suitable for recognition of a voice based on a voice level indicating a level of a person's voice which is detected in the vehicle, a noise level indicating a level of noise which is detected in the vehicle, and a threshold value for determining whether the environment in the vehicle is suitable for recognition of a voice. The emission control step is a process of changing an emission state of a light emitting unit provided in the vehicle to a first state when it is determined in the determination step that the environment in the vehicle is suitable for recognition of a voice and changing the emission state of the light emitting unit to a second state which is different from the first state when it is determined in the determination step that the environment in the vehicle is not suitable for recognition of a voice.

As described above, the voice recognition supporting device 100-1 according to the first embodiment includes an emission control unit that changes the emission state of the light emitting unit to a first state when it is determined that the environment in the vehicle is suitable for recognition of a voice and changes the emission state of the light emitting unit to a second state which is different from the first state when it is determined that the environment in the vehicle is not suitable for recognition of a voice. According to this configuration, an occupant in the vehicle can understand whether a current environment is suitable for voice recognition based on the emission state of the light emitting unit. Since an occupant can understand whether the current environment is suitable for voice recognition, it is possible to prevent an increase in a person's cognitive load in comparison with the related art described above.

### Second Embodiment

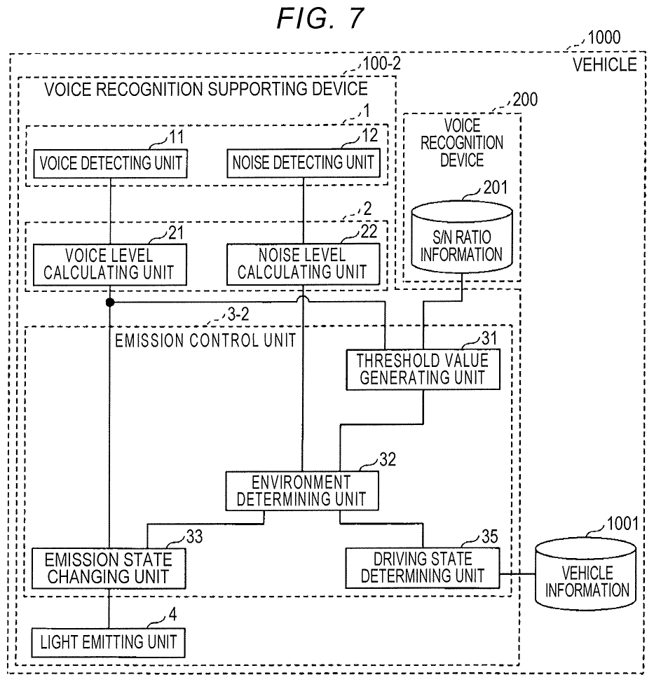

FIG. 7 is a diagram illustrating an example of a configuration of a voice recognition supporting device according to a second embodiment of the disclosure. The voice recognition supporting device 100-2 according to the second embodiment is different from the voice recognition supporting device 100-1 according to the first embodiment, in that an emission control unit 3-2 is provided instead of the emission control unit 3-1 and the emission control unit 3-2 includes a driving state determining unit 35 in addition to a threshold value generating unit 31, an environment determining unit 32, and an emission state changing unit 33. The driving state determining unit 35 determines whether it is necessary to suppress utterance of a voice based on vehicle information 1001 which is acquired from the vehicle and outputs the determination result as driving state information indicating a driving state.

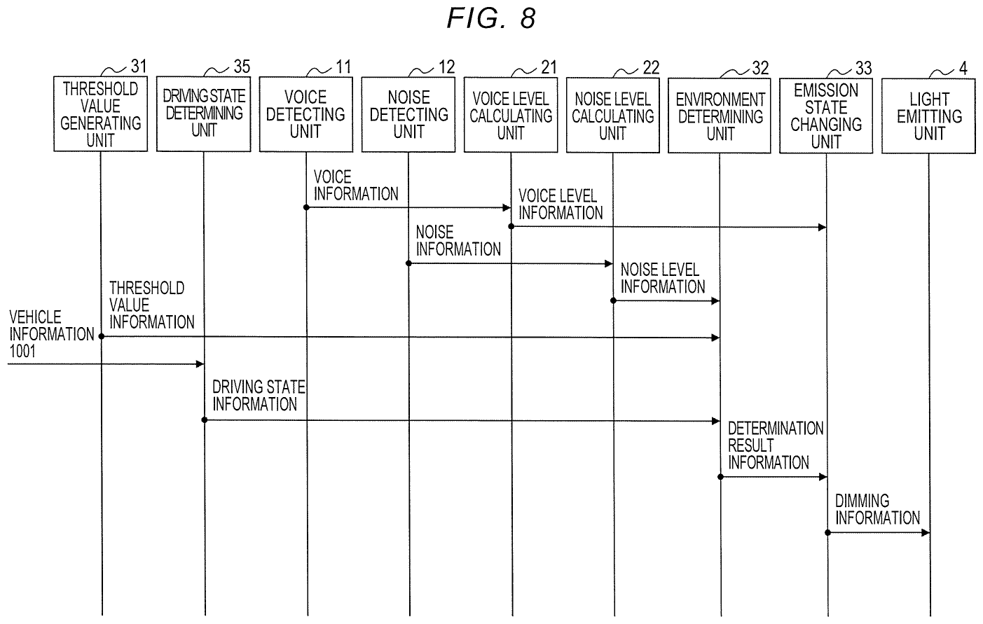

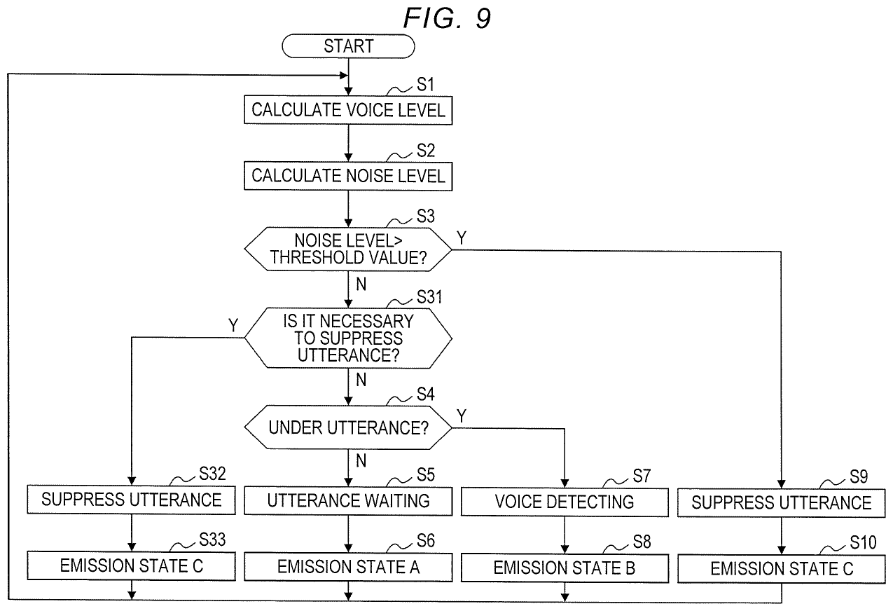

An operation of the voice recognition supporting device 100-2 will be described below with reference to FIGS. 8 to 9. FIG. 8 is a sequence chart illustrating the operation of the voice recognition supporting device according to the second embodiment of the disclosure. FIG. 9 is a flowchart illustrating the operation of the voice recognition supporting device according to the second embodiment of the disclosure. The sequence chart illustrated in FIG. 8 is different from the sequence chart illustrated in FIG. 2, in that the driving state determining unit 35 is added and driving state information which is output from the driving state determining unit 35 is input to the environment determining unit 32. The flowchart illustrated in FIG. 9 is different from the flowchart illustrated in FIG. 3, in that Step S31 is additionally provided between Step S3 and Step S4 and Steps S32 and S33 are additionally provided. The processes other than Steps S31, S32, and S33 are the same as the processes of the steps illustrated in FIG. 3 and thus description thereof will not be repeated.

When it is determined in Step S3 that the noise level is not greater than the threshold value (NO in Step S3), the process of Step S31 is performed. In Step S31, the driving state determining unit 35 determines whether a driving state of a driver is suitable for utterance of a voice based on the vehicle information 1001 acquired from the vehicle. The vehicle information 1001 is, for example, information indicating a running speed of the vehicle, information indicating a steering state of a steering device, information indicating a brake operation state, or information which is acquired from an advanced driver-assistance systems (ADAS). The ADAS is a system that supports a driving operation of a driver in order to improve convenience in road traffic.

For example, when the vehicle information 1001 is information indicating a steering state, the driving state determining unit 35 can determine whether the vehicle is running on a straight road or a curved road by analyzing the vehicle information 1001. When the vehicle information 1001 is information indicating a running speed, the driving state determining unit 35 can determine whether the vehicle is running at a low speed or running at a high speed by analyzing the vehicle information 1001. For example, when the vehicle is running on a curved section of a highway at 100 km/h, there is a high likelihood that a voice operation at that time will cause a decrease in a driver's attention. Accordingly, the driving state determining unit 35 determines that it is necessary to suppress utterance of a voice. On the other hand, for example, when the vehicle is running on a straight section of a regular road at 30 km/h, there is a low likelihood that a voice operation at that time will cause a decrease in a driver's attention. Accordingly, in such a situation, the driving state determining unit 35 determines that it is not necessary to suppress utterance of a voice.

In this way, the driving state determining unit 35 determines whether it is necessary to suppress utterance of a voice based on the vehicle information 1001. When it is necessary to suppress utterance of a voice (YES in Step S31), the driving state determining unit 35 outputs driving state information indicating a driving state in which it is necessary to suppress utterance of a voice to the environment determining unit 32. The environment determining unit 32 having received the driving state information determines that it is necessary to prompt an occupant to suppress utterance of a voice because the environment in the vehicle is not suitable for recognition of a voice (Step S32). The emission state changing unit 33 having received the determination result information outputs dimming information using the emission state correspondence table to prompt an occupant to suppress utterance of a voice. The dimming information is information for controlling the emission state of the light emitting unit 4 such that the state of the light emitting unit 4 is set to “emission state C” (Step S33).

Referring back to Step S31, when it is not necessary to suppress utterance of a voice (NO in Step S31), the driving state determining unit 35 outputs driving state information indicating a driving state in which it is not necessary to suppress utterance of a voice to the environment determining unit 32. The environment determining unit 32 having received the driving state information performs the process of Step S4.

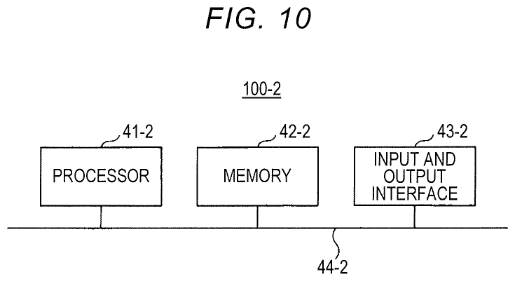

FIG. 10 is a diagram illustrating an example of a hardware configuration for embodying the voice recognition supporting device according to the second embodiment of the disclosure. The voice recognition supporting device 100-2 can be embodied by a processor 41-2 such as a CPU or a system LSI circuit, a memory 42-2 including a RAM and a ROM, and an input and output interface 43-2. The processor 41-2 may be a computing means such as a microcomputer or a DSP. The processor 41-2, the memory 42-2, and the input and output interface 43-2 are connected to a bus 44-2 and can transmit and receive information to and from each other via the bus 44-2. The input and output interface 43-2 enables the voice recognition supporting device 100-2 to transmit and receive information to and from the voice recognition device 200 and the light emitting unit 4. When the voice recognition supporting device 100-2 is embodied, the sound level calculating unit 2 and the emission control unit 3-2 are embodied by storing a program for the voice recognition supporting device 100-2 in the memory 42-2 and causing the processor 41-2 to execute the program.

As described above, the voice recognition supporting device 100-2 according to the second embodiment is configured to determine whether the environment in the vehicle is suitable for recognition of a voice based on vehicle information acquired from the vehicle in addition to the voice level and the noise level. According to this configuration, it is possible to provide a comfortable driving environment effectively using the voice recognition device 200 while suppressing utterance of a voice in a driving state in which there is a high likelihood that a decrease in a driver's attention will be caused.

The emission control unit 3-2 in the second embodiment may be configured to determine that the environment in the vehicle is suitable for recognition of a voice when the vehicle information is, for example, vehicle speed information and it is determined that the vehicle is not running based on the vehicle speed information. By employing this configuration, an occupant can use the voice recognition device 200 without being aware of the emission state of the light emitting unit 4. The emission control unit 3-2 in the second embodiment may be configured to turn off the light emitting unit 4 when the vehicle information is, for example, vehicle speed information and it is determined that the vehicle is not running based on the vehicle information. By employing this configuration, it is possible to curb consumption of power which is required for emission of light from the light emitting unit 4.

The emission control unit 3-2 in the second embodiment may be configured to stepwise or continuously change an emission amount of the light emitting unit 4 under utterance waiting, for example, depending on a vehicle speed or a steering angle of a steering wheel. Specifically, an emission amount under utterance waiting is adjusted depending on speed classifications such as a first speed area (0 km/h to 10 km/h), a second speed area (11 km/h to 20 km/h), and a third speed area (21 km/h to 30 km/h). For example, the emission amount under utterance waiting decreases in the order of the first speed area, the second speed area, and the third speed area. The emission amount under utterance waiting is adjusted depending on angle classifications of the steering angle of the steering wheel such as small (equal to or less than 10 degrees), middle (11 degrees to 90 degrees), and large (equal to or greater than 91 degrees). Specifically, the emission amount under utterance waiting decreases in the order of small, middle, and large steering angles. According to this configuration, it is possible to access an utterance-suppressed state and to curb a decrease in a driver's attention in comparison with a case in which the emission amount under utterance waiting is constant.

The emission control unit 3-2 in the second embodiment may be configured to continuously change a flickering cycle of the light emitting unit 4 under voice detecting, for example, depending on a vehicle speed and a steering angle of a steering wheel. For example, the flickering cycle under voice detecting is adjusted depending on the speed classifications. Specifically, the flickering cycle decreases in the order of the first speed area, the second speed area, and the third speed area. The flickering cycle under voice detecting is adjusted depending on the angle classifications of the steering angle of the steering wheel. Specifically, the flickering cycle decreases in the order of small, middle, and large steering angles. According to this configuration, since the flickering cycle can vary, it is difficult to miss a turned-on state of the light emitting unit 4 even when an attention is attracted to driving and the attention varies depending on the driving state, in comparison with a case in which the flickering cycle under voice detecting is constant. Accordingly, it is possible to provide more comfortable driving environment effectively using the voice recognition device 200

In the first and second embodiments, a configuration example in which the voice recognition supporting device is provided in a vehicle has been described, but the voice recognition supporting devices according to the first and second embodiments can be applied to all devices or machines (for example, an interactive robot, a railway vehicle, or an aircraft) using voice recognition.

What is claimed is:

1. A voice recognition supporting device comprising:
a light emitting unit;
a sound detecting unit; and
an emission control unit configured to determine whether an environment around the sound detecting unit is suitable for recognition of a voice based on a voice level indicating a level of a person's voice which is detected by the sound detecting unit, a noise level indicating a level of noise which is detected by the sound detecting unit, and a threshold value for determining whether an environment around the sound detecting unit is suitable for recognition of a voice, to change an emission state of the light emitting unit to a first state when it is determined that the environment around the sound detecting unit is suitable for recognition of a voice, and to change the emission state of the light emitting unit to a second state which is different from the first state when it is determined that the environment around the sound detecting unit is not suitable for recognition of a voice.

2. The voice recognition supporting device according to claim 1, wherein the emission control unit is configured to determine whether an environment in a vehicle is suitable for recognition of a voice based on vehicle information which is acquired from the vehicle in addition to the voice level and the noise level.

3. The voice recognition supporting device according to claim 2, wherein the emission control unit is configured to determine that the environment in the vehicle is suitable for recognition of a voice when it is determined that the vehicle is not running based on the vehicle information.

4. The voice recognition supporting device according to claim 3, wherein the emission control unit is configured to turn off the light emitting unit when it is determined that the vehicle is not running.

5. A voice recognition supporting program causing a computer to perform:
a determination step of determining whether an environment around a sound detecting unit is suitable for recognition of a voice based on a voice level indicating a level of a person's voice which is detected by the sound detecting unit, a noise level indicating a level of noise which is detected by the sound detecting unit, and a threshold value for determining whether an environment around the sound detecting unit is suitable for recognition of a voice; and
an emission control step of changing an emission state of a light emitting unit to a first state when it is determined in the determination step that the environment around the sound detecting unit is suitable for recognition of a voice and changing the emission state of the light emitting unit to a second state which is different from the first state when it is determined in the determination step that the environment around the sound detecting unit is not suitable for recognition of a voice.
